(19) United States
(12) Patent Application Publication
(10) Pub. No.: US 2011/0033352 A1
(43) Pub. Date: Feb. 10, 2011

(54) CATALYST/CATALYST SUPPORT COMPOSITIONS COMPRISING THE OXIDES OF ZIRCONIUM, YTTRIUM AND TUNGSTEN

(75) Inventors: Olivier Larcher, Pennington, NJ (US); Emmanuel Rohart, Sainte Soulle (FR); Stephan Verdier, Lyon (FR); Guillaume Criniere, Ixelles (BE); Deborah Harris, Manchester (GB); Heather Bradshaw, Bury (GB)

Correspondence Address: BUCHANAN, INGERSOLL & ROONEY PC, POST OFFICE BOX 1404, ALEXANDRIA, VA, 22313-1404, US

(73) Assignee: RHODIA OPERATIONS, Aubervilliers (FR)

(21) Appl. No.: 12/812,316

(22) PCT Filed: Jan. 6, 2009
(86) PCT No.: PCT/EP09/50074

§ 371 Date: Oct. 27, 2010

(30) Foreign Application Priority Data
Jan. 9, 2008 (FR) 0800115

(51) Int. Cl. B01J 21/06; B01J 37/03; B01J 37/06; B01J 37/08; B01D 53/94; B01D 53/62; B01D 53/72; B01D 53/56

(52) U.S. Cl. 423/213.2; 502/308; 502/302

(57) ABSTRACT

Compositions based on zirconium oxide, including 1 to 20% yttrium oxide, 1 to 30% tungsten oxide and the balance zirconium oxide, have a specific surface area of at least 40 m²/g after calcination at 700° C. for 4 hours and an acidity measured by the methylbutynol test of at least 90%, and are useful as catalyst or catalyst supports, especially for the treatment of motor vehicle exhaust gases.

The present invention relates to a composition based on zirconium oxide, yttrium oxide and tungsten oxide, to the process for preparing it and to its use as a catalyst or catalyst support.

It is known that, in order to be effective, catalysts and compositions intended to act as a support for said catalysts should have a large specific surface area. In addition, catalysts capable of being used at increasingly high temperatures and, for this, catalysts which have an improved specific surface area stability, are always being sought. This is most particularly the case for catalysts or supports thereof used for the treatment of exhaust gases from the engines of motor vehicles.

Moreover, in an even more specific case, such as the treatment of gases from diesel engines by reduction of nitrogen oxides (NOx) using aqueous ammonia or urea, catalysts which have a certain acidity and, here also, a certain temperature resistance, are needed.

Finally, in certain applications, products which do not contain any silicon may be demanded, since it is known that, under certain conditions, silicon can react with the precious metals normally used in catalysts and thus deteriorate the performances thereof.

The object of the invention is to provide materials that can be used in the manufacture of catalysts, which meet these needs.

With this aim, the composition according to the invention is based on zirconium oxide, yttrium oxide and tungsten oxide. These oxides are present in the composition in the following proportions by mass:
yttrium oxide: 1% to 20%;
tungsten oxide: 1% to 30%;
   the remainder being zirconium oxide.

Other features, details and advantages of the invention will emerge even more completely on reading the description which follows, and also in a concrete but nonlimiting example intended to illustrate it.

For the remainder of the description, the term “specific surface area” is intended to mean the B.E.T. specific surface area determined by nitrogen adsorption in accordance with the ASTM D 3663-78 standard established from the Brunauer-Emmett-Teller method described in the periodical “The Journal of the American Chemical Society, 60, 309 (1938)”.

The calcinations at the conclusion of which the surface area values are given are calcinations in air.

The specific surface area values which are shown for a given temperature and a given period of time correspond, unless otherwise indicated, to calcinations in air at a stationary temperature over the period of time shown.

The contents are given by mass and as oxide, unless otherwise indicated.

It is also specified that, for the remainder of the description, unless otherwise indicated, in the ranges of values which are given, the values at the limits are included.

The composition according to the invention is first characterized by the nature of its constituents. As was indicated above, this composition is based on zirconium oxide and it also comprises yttrium oxide and tungsten oxide in the proportions which are given above.

The yttrium oxide content may be more particularly between 5% and 15% and that of tungsten oxide between 5% and 20%.

According to various variants, the compositions of the invention may contain only zirconium oxide, yttrium oxide and tungsten oxide, but, in addition, they may also contain at least one oxide of a rare earth element other than cerium. The term “rare earth element” is here intended to mean the elements of the group consisting of the elements of the Periodic Table of Elements with an atomic number of between 57 and 71 inclusive. This rare earth element may more particularly be lanthanum, praseodymium or neodymium, it being possible for these elements to also be present in combination.

In the case of the presence, in the composition, of a rare earth element other than cerium, the amounts of yttrium and of tungsten are the same as those given above, the amount of rare earth element can then be between 1% and 10%, more particularly between 2% and 7%, the remainder being zirconium oxide. The presence of a rare earth element in the composition has the effect of stabilizing its specific surface area at high temperature.

Another additional feature of the compositions of the invention is their specific surface area. The latter may be at least 40 m²/g, more particularly at least 60 m²/g, and even more particularly at least 70 m²/g after calcination at 700° C. for 4 hours. Surface areas ranging up to at least approximately 90 to 120 m²/g can be obtained for these calcination conditions, the surface area generally being higher, the lower the tungsten content of the composition.

In addition, after calcination at 900° C. for 4 hours, this surface area may be at least 10 m²/g, more particularly at least 20 m²/g, and even more particularly at least 26 m²/g or alternatively at least 29 m²/g.

Another advantageous feature of the compositions of the invention is their acidity. This acidity is measured by the methylbutynol test, which will be described later, and it is at least 90%, and more particularly it can be at least 95%. This acidity can also be evaluated by the acidic activity, which is also measured using the methylbutynol test and which characterizes an acidity of the product independently of its surface area.

This acidic activity is at least 0.03 mmol/h/m², more particularly at least 0.075 mmol/h/m². It may even more particularly be at least 0.1 mmol/h/m², and in particular at least 0.15 mmol/h/m², these values being given for a composition having undergone a calcination at 700° C. for 4 hours.

The compositions of the invention may be in the form of a mixture of crystallographic phases in which the predominant phase is that of a zirconium oxide crystallized in the tetragonal or cubic system.

According to a specific embodiment, the compositions of the invention may be in the form of solid solutions of the yttrium and tungsten elements in the zirconium oxide.

In this case, the XR diffraction diagrams of these compositions reveal the existence of a single phase corresponding to that of a zirconium oxide crystallized in the tetragonal or cubic system, thus reflecting the incorporation of the yttrium and tungsten elements in the crystalline network of zirconium oxide, and thus the obtaining of a true solid solution. The high contents of yttrium generally promote the appearance of the cubic phase. This solid-solution embodiment applies to compositions which have undergone a calcination at 700° C. for 4 hours. This signifies that, after calcination under these conditions, no demixing, i.e. the appearance of other phases, is observed.

The compositions of the invention may also have a sulphate content which may be very low. This content may be at most 800 ppm, more particularly at most 500 ppm, even more particularly at most 100 ppm, this content being expressed by mass of SO₄ relative to the entire composition and measured by means of a Leco or Eltra apparatus, i.e. by means of a technique which implements catalytic oxidation of the product of an induction oven and IR analysis of the SO₂ formed.

Moreover, the compositions of the invention may also have a chlorine content which may be very low. This content may be at most 500 ppm, in particular at most 200 ppm, more specifically at most 100 ppm, more particularly at most 50 ppm, and even more particularly at most 10 ppm. This content is expressed by mass of Cl relative to the entire composition.

Finally, the compositions of the invention may also have an alkali element content, in particular sodium content, of at most 500 ppm, in particular at most 200 ppm, more particularly at most 100 ppm, even more particularly at most 50 ppm. This content is expressed by mass of element, for example mass of Na, relative to the entire composition.

These chlorine and alkali element contents are measured by the ionic chromatography technique.

The process for preparing the compositions of the invention will now be described.

This process is characterized in that it comprises the following steps:
(a) a zirconium compound, an yttrium compound, optionally a compound of a rare earth element other than cerium, and a basic compound are brought together in a liquid medium, whereby a precipitate is obtained;
(b) optionally, said precipitate is separated, washed and resuspended;
(c) a tungsten compound is added to the medium derived from step (a) or from step (b), as is an acid so as to bring the pH of the medium formed to a value of between 2 and 7;
(d) optionally, the precipitate derived from the preceding step is washed, after separation from the precipitation medium;
(e) the precipitate derived from step (c) or (d) is calcined.

The various steps above will be described in greater detail.

The first step of the process consists in bringing together, in the liquid medium, a zirconium compound and an yttrium compound. These compounds are present in the stoichiometrical proportions necessary for obtaining the desired final composition. In the case of the preparation of a composition comprising a rare earth element according to the variant described above, a compound of this rare earth element is also used in this first step.

The liquid medium also comprises a basic compound.

The liquid medium is generally water.

The compounds are preferably soluble compounds. The zirconium compound may be a nitrate which may have been obtained, for example, by nitric acid attack of a zirconium hydroxide. This may also be a chloride or sulphate. According to a specific variant, a zirconium oxychloride is used.

For the yttrium compound or the rare earth element compound, inorganic or organic salts of these elements may be used. The chloride or the acetate, and more particularly the nitrate, may be mentioned.

Products of the hydroxide or carbonate type may be used as basic compound. Mention may be made of alkali metal hydroxides or alkaline earth metal hydroxides and aqueous ammonia. Use may also be made of secondary, tertiary or quaternary amines. Urea may also be mentioned.

It is possible to carry out this step (a) of the process in the presence of additives intended to facilitate the implementation thereof, in particular for facilitating the subsequent treatment of the precipitate. These additives may be chosen from compounds of sulphate type, phosphates or polycarboxylates.

The term “compound of sulphate type” is intended to mean any compound comprising the SO₄²⁻ anion or capable of producing this anion. This compound may be sulphuric acid, ammonium sulphate, an alkali metal sulphate, in particular sodium sulphate or potassium sulphate.

The bringing together of the various compounds may be carried out in any way. The yttrium compound may thus be introduced with the zirconium compound into a reactor containing as tank starters the basic compound and the sulphate compound.

This first step is generally carried out at ambient temperature (15-35° C.).

At the end of step (a), a solid precipitate is obtained.

The process subsequently comprises an optional step (b) in which the precipitate can be separated from its medium by any conventional solid-liquid separation technique, such as, for example, filtration, settling out, spin-filtering or centrifugation. The product is subjected to one or more washes, with water or with acidic or basic aqueous solutions. At the end of this washing, the precipitate is resuspended in water and the following step (c) of the process is carried out.

This step (c) consists in adding to the medium derived from the preceding step (step (a) or (b) if the latter has been carried out) a tungsten compound. This compound may be an inorganic salt such as ammonium metatungstate (NH₄)₆W₁₂O₄₁ or sodium metatungstate Na₂WO₄, in particular. Moreover, an acid is also added so as to bring the pH of the medium formed to a value of between 2 and 7, more particular between 4 and 6. This acid may be an inorganic acid such as nitric acid.

The process subsequently comprises a step (d) which is optional. This step consists in separating the precipitate obtained in the preceding step from its precipitation medium, in the same manner as described above for step (b), then in washing the precipitate thus obtained one or more times.

It will be noted that, according to a preferred embodiment, the process comprises at least one washing step (b) or (d) and even more preferably these two steps, in particular when it is sought to obtain compositions with low sulphate, chlorine or alkali metal contents.

The last step of the process is a calcination of the precipitate derived from step (c) or (d), this calcination optionally being preceded by drying. This calcination makes it possible to develop the crystallinity of the product formed, and it can also be adjusted according to the subsequent working temperature intended for the composition, taking into account the fact that, the higher the calcination temperature used, the lower the specific surface area of the product. Such a calcination is generally carried out in air.

In practice, the calcination temperature is generally limited to a range of values of between 500° C. and 900° C., more particularly between 700° C. and 900° C.

The duration of this calcination can vary within broad limits; it is in principle longer, the lower the temperature. By way of example only, this duration may range between 2 hours and 10 hours.

The compositions of the invention as described above or as obtained by means of the process described above are in the form of powders, but they may optionally be shaped so as to be in the form of granules, beads, cylinders, monoliths or filters in the form of honeycombs of variable dimensions. These compositions may be applied to any support commonly used in the field of catalysis, i.e. in particularly thermally inert supports. This support may be chosen from alumina, titanium oxide, cerium oxide, zirconium oxide, silica, spinels, zeolites, silicates, crystalline silicoaluminium phosphates or crystalline aluminium phosphates.

The compositions may also be used in catalytic systems. The invention thus also relates to catalytic systems containing compositions of the invention. These catalytic systems may comprise a coating (wash coat), which has catalytic properties and which is based on these compositions, on a substrate of, for example, the metal monolith or ceramic monolith type. The coating can itself also comprise a support of the type of those mentioned above. This coating is obtained by mixing the composition with the support so as to form a suspension, which can subsequently be deposited onto the substrate.

In the case of these uses in the catalytic systems, the compositions of the invention may be employed in combination with transition metals; these thus act as support for these metals. The term “transition metals” is intended to mean the elements from groups IIIA to IIB of the Periodic Table of Elements. As transition metals, mention may more particularly be made of vanadium and copper, and also precious metals, such as platinum, rhodium, palladium, silver or iridium. The nature of these metals and the techniques for incorporating them into the support compositions are well known to those skilled in the art. For example, the metals may be incorporated into the compositions by impregnation.

The systems of the invention can be used in the treatment of gases. In this case, they can act as catalysts for the oxidation of the CO and the hydrocarbons present in these gases or else as catalysts for reducing the nitrogen oxides (NOx) in the reaction for the reduction of these NOx with aqueous ammonia or urea and, in this case, as catalysts for the reaction for hydrolysis or decomposition of the urea to aqueous ammonia (SCR process).

The gases that can be treated in the context of the present invention are, for example, those emitted by stationary installations, such as gas turbines or power station boilers. They may also be the gases resulting from internal combustion engines and most particularly exhaust gases from diesel engines.

In the case of the use in catalysis of the reaction for the reduction of NOx with aqueous ammonia or urea, the compositions of the invention may be employed in combination with cerium or with metals of the transition metal type, such as vanadium or copper.

An example will now be given.

A description is first of all given below of the methylbutynol test used to characterize the acidity of the compositions according to the invention.

This catalytic test is described by Pernot et al., in Applied Catalysis, 1991, vol. 78, p 213, and uses 2-methyl-3-butyn-2-ol (methylbutynol or MBOH) as probe molecule for the surface acidity/basicity of the compositions prepared. Depending on the acidity/basicity of the surface sites of the composition, the methylbutynol can be converted according to 3 reactions:

TABLE 1

| Reaction | Reaction products |
|---|---|
| Acidic | 2-Methyl-1-buten-3-yne + 3-methyl-2-butenal |
| Amphoteric | 3-Hydroxy-3-methyl-2-butanone + 3-methyl- |
| | 3-buten-2-one |
| Basic | Acetone + acetylene |

Experimentally, an amount (m) of approximately 400 mg of composition is placed in a quartz reactor. The composition is first subjected to a pretreatment at 400° C. for 2 h under an N₂ gas flow at a flow rate of 4 l/h.

The temperature of the composition is subsequently brought to 180° C. The composition is then periodically brought into contact with given amounts of MBOH. This operation of bringing into periodic contact consists in circulating, during an injection of 4 minutes, a synthetic mixture of 4 vol % of MBOH in N₂ with a flow rate of 4 l/h, which corresponds to an hourly molar flow rate of methylbutynol (Q) of 7.1 mmol/h. 10 injections are carried out. At the end of each injection, the gas stream at the reactor outlet is analyzed by gas chromatography to determine the nature of the reaction products (cf. Table 1) and their amount.

The selectivity (Sᵢ) for a product i of the methylbutynol conversion reaction is defined by the proportion of this product with respect to all the products formed (Sᵢ=Cᵢ/Σ where Cᵢ is the amount of product i and Σ represents the sum of the products formed during the reaction). An acidic, amphoteric or basic selectivity is then defined, which is equal to the sum of the selectivities of the products formed in the acidic, amphoteric and basic reactions respectively. For example, the acidic selectivity (S[acidic]) is equal to the sum of the selectivities for 2-methyl-1-buten-3-yne and for 3-methyl-2-butenal. Thus, the greater the acidic selectivity, the greater the amounts of acidic reaction products formed and the greater the number of acidic sites on the compositions studied.

The degree of conversion of the methylbutynol (DC) during the test is calculated by taking the mean of the degrees of conversion of the methylbutynol over the final 5 injections of the test.

The acidic activity (A[acidic]) of the composition, expressed in mmol/h/m², can also be defined from the degree of conversion of the methylbutynol (DC, expressed as %), the hourly molar flow rate of the methylbutynol (Q, expressed as mmol/h), the acidic selectivity (S[acidic] expressed as %), the amount of composition analyzed (m, expressed in g) and the specific surface area of the composition (SBET, expressed in m²/g), according to the following relationship:

A[acidic]=10⁻⁴·DC·Q·S[acidic]/(SBET·m)

### EXAMPLE

This example relates to the preparation of a composition based on zirconium oxide, yttrium oxide and tungsten oxide in the respective proportions by mass of oxide of 70%, 10% and 20%.

A solution A is prepared by mixing, in a beaker with stirring, 219 g of zirconyl chloride (20 wt % ZrO₂), 18 g of sulphuric acid (97 wt %) and 27 g of yttrium nitrate (391 g/l Y₂O₃) with 93 g of deionized water.

657 g of sodium hydroxide solution (10 wt % NaOH) and 50 g of deionized water are introduced into a stirred reactor. Solution A is then gradually added with stirring. The pH of the medium reaches a value of at least 12.5 by subsequently adding a solution of sodium hydroxide. The precipitate obtained is filtered off and washed at 60° C. with 3 l of deionized water. The solid is resuspended and the suspension is made up to 714 g with deionized water.

A solution B is prepared by mixing 17.8 g of sodium metatungstate dihydrate and 45 g of deionized water. Solution B is then added to the suspension gradually, with stirring. The pH is subsequently adjusted to 5.5 by adding a solution of nitric acid (68 vol %). The precipitate is again filtered off and washed at 45° C. with 3 l of deionized water.

The solid is dried overnight in an oven at 120° C. and the product obtained is then calcined in air at 700° C. for 4 hours under stationary conditions. This product is characterized by a specific surface area of 68 m²/g and a pure tetragonal phase. After calcination in air at 900° C. for 4 hours under stationary conditions, the specific surface area is equal to 29 m²/g.

The product contains 50 ppm of sodium, less than 10 ppm of chlorides and less than 120 ppm of sulphates.

In the methylbutynol test, the product calcined at 700° C./4 h has an acidic selectivity of 97% and an acidic activity of 0.171 mmol/m²/h.

1.-13. (canceled)

14. A catalyst/catalyst support composition comprising zirconium oxide, yttrium oxide and tungsten oxide in the following proportions by mass:
yttrium oxide: 1% to 20%;
tungsten oxide: 1% to 30%; and
the remainder being zirconium oxide.

15. The catalyst/catalyst support composition as defined by claim 14, having a yttrium oxide content ranging from 5% to 15%.

16. The catalyst/catalyst support composition as defined by claim 14, having a tungsten oxide content ranging from 5% to 20%.

17. The catalyst/catalyst support composition as defined by claim 14, having a specific surface area of at least 40 m²/g after calcination at 700° C. for 4 hours.

18. The catalyst/catalyst support composition as defined by claim 14, having a specific surface area of at least 10 m²/g after calcination at 900° C. for 4 hours.

19. The catalyst/catalyst support composition as defined by claim 14, having an acidity measured by the methylbutynol test of at least 90%.

20. The catalyst/catalyst support composition as defined by claim 14, further comprising an oxide of a rare earth element other than cerium in a proportion ranging from 1% to 10% by mass.

21. The catalyst/catalyst support composition as defined by claim 14, having a specific surface area of at least 70 m²/g after calcination at 700° C. for 4 hours.

22. The catalyst/catalyst support composition as defined by claim 14, having a specific surface area of at least 20 m²/g after calcination at 900° C. for 4 hours.

23. The catalyst/catalyst support composition as defined by claim 14, comprising a mixture of crystallographic phases.

24. The catalyst/catalyst support composition as defined by claim 14, comprising solid solutions of yttrium and tungsten in the zirconium oxide.

25. The catalyst/catalyst support composition as defined by claim 14, having a sulfate content of at most 800 ppm.

26. The catalyst/catalyst support composition as defined by claim 14, having a chlorine content of at most 500 ppm.

27. The catalyst/catalyst support composition as defined by claim 14, having an alkali element content of at most 500 ppm.

28. A process for preparing a catalyst/catalyst support composition as defined by claim 14, comprising the following steps:
(a) bringing together a zirconium compound, a yttrium compound, optionally a compound of a rare earth element other than cerium, and a basic compound in a liquid medium, whereby a precipitate is obtained;
(b) optionally, said precipitate is separated, washed and resuspended;
(c) adding a tungsten compound to the medium derived from step (a) or from step (b), as is an acid such as to adjust the pH of the medium formed to a value ranging from 2 to 7;
(d) optionally, the precipitate derived from the preceding step is washed, after separation from the precipitation medium;
(e) calcining the precipitate derived from step (c) or (d).

29. The process as defined by claim 28, wherein the zirconium compound is a zirconium oxychloride.

30. The process as defined by claim 28, wherein step (a) is carried out in the presence of an additive selected from among sulfate, phosphate or polycarboxylate compounds.

31. A catalytic system comprising a composition as defined by claim 14.

32. A process for treating exhaust gases from a diesel engine, comprising oxidizing the CO and the hydrocarbons present therein in the presence of a catalyst/catalyst support composition as defined by claim 14.

33. A process for treating exhaust gases from a diesel engine, comprising reducing the nitrogen oxides (NOx) contained therein with aqueous ammonia or urea in the presence of a catalyst/catalyst support composition as defined by claim 14.
